(19) United States
(12) Patent Application Publication
(10) Pub. No.: US 2009/0235082 A1
(43) Pub. Date: Sep. 17, 2009

(54) System for Conducting Secure Digital Signing of and Verification of Electronic Documents

(76) Inventor: Peter Garrett, Aptos, CA (US)

Correspondence Address: CENTRAL COAST PATENT AGENCY, INC, 3 HANGAR WAY SUITE D, WATSONVILLE, CA, 95076, US

(21) Appl. No.: 12/046,691

(22) Filed: Mar. 12, 2008

(51) Int. Cl. H04L 9/00

(52) U.S. Cl. 713/178; 713/176

(57) ABSTRACT

A system for rendering a secure digital signature includes a computerized signature tool for rendering a signature, an identity verification program accessible to the computerized signature tool, and a biometric scanner coupled to or integrated with the computerized signature tool. A signatory uses the computerized signature tool to render a signature, the user authenticated as a signatory by retrieving a biometric identifier from the user via the biometric scanner and matching the retrieved biometric identifier to a pre-stored biometric identifier via the identity verification program.

### BACKGROUND OF THE INVENTION

1. Field of the Invention

The present invention is in the field of electronic security, particularly relating to signatures applied to legal documents and transactions, and pertains more particularly to a system and methods for facilitating secure and reliable signatures on legal documents and transactions.

2. Discussion of the State of the Art

In the field of electronic security, regimens for verifying identities of signatories on electronic documents and in electronic transactions are continuously being evaluated and developed. Various methods for identifying signatures and validating those signatures to the owners have been developed.

Some of these methods use some form of biometrics whereby a user is required to submit to having, for example, a thumbprint on file that can be matched to a current scan of the user's thumbprint whenever the user is accessing otherwise protected information. Voice metrics, retina scans, and other biometric regimens continue to be explored. Other more traditional methods include online signature matching, key-based identity verification, and others. Other systems use a stylus connected to a computer where the stylus is used to perform a signature on a digital reader that transfers the signature into the computer where it may be eventually compared with a sample signature on file for accuracy.

Some of these methods are more secure than others. One drawback to state-of-the-art technology is that there are currently no systems or methods in the art that treat the security concerns over a signature of a document as well as the complete validity or authenticity of the document itself.

Therefore, what is needed in the art is a system and methods for facilitating secure signing of an electronic document while also providing authentication for each page of the document.

### SUMMARY OF THE INVENTION

The problem stated above is that document authenticity as well as signature verification of document signatories are desired for execution of legal documents, but many of the conventional means for creating and executing legal agreements, such as service contracts, purchase agreements, licensing agreements and the like also leave doubt about the integrity of the content of the document and the identity of signatories to the document. The inventors therefore considered functional elements of a document processing and signature verification system, looking for elements that could be tapped to facilitate the kind of security that potentially be implemented in a network-based environment to provide executable legal documents in a manner that would not leave any doubt about the identities of document signers or contents integrity of the document.

Every critical business dealing is exemplified by one or more legal documents, one by-product of which is an abundance of work and time devoted to preparing legal documents and getting those documents properly signed. Most such legal documents must be signed in the presence of a witness and may be subject under certain circumstance to unauthorized editing.

The present inventor realized in an inventive moment that if, at the point of signature of a legal document, the signatories could be authenticated without reservation and document content integrity could be protected with a reasonable assurance level, significant time savings might result in execution of document goals. The inventor therefore constructed a unique verification system and network for validating legal documents online that allowed signatories to be independently validated during signature execution while preserving the integrity of the contents of the document. A significant time savings and organizational improvement in contract management results with reduced reliance on traditionally slow certification processes.

Accordingly, a system for rendering a secure digital signature is provided. The system includes a computerized signature tool for rendering a signature, an identity verification program accessible to the computerized signature tool, and a biometric scanner coupled to or integrated with the computerized signature tool. A signatory uses the computerized signature tool to render a signature, the user authenticated as a signatory by retrieving a biometric identifier from the user via the biometric scanner and matching the retrieved biometric identifier to a pre-stored biometric identifier via the identity verification program.

According to another embodiment, a computerized signature tool for signing a printed document is provided. The tool includes an ink dispensing well and tip for controlling ink flow, a biometric scanner for scanning a biometric identifier, a motion sensor for sensing motion of the dispensing tip, an onboard memory for storing biometric data and motion data; and a digital communication link to a host computing device.

According to another embodiment of the invention, a secure document processing and signature authentication network is provided. The network includes a first computer node for preparing a document for signature by pre-identifying all of the signatories to that document, a data storage system accessible to the first computer node for storing biometric identifiers of the pre-identified signatories, a second computer node in communication with the first computer node, the second computer node for receiving the prepared document from the first computer node and for presenting the document for signature. The presented document identifies the required signatories and wherein the second computer node cooperates with the first computer node to authenticate each signatory upon signing, the second computer node recording the signature process and providing date and time sensitive notification of successful completion of each signature.

In one aspect of the invention, using a computerized signature tool, the tool coupled to or integrated with a biometric scanner, a method for authenticating a signatory of a legal document comprising the steps, (a) pre-scanning a biometric feature of the signatory,(b) generating biometric identifier of the signatory from the pre-scanned biometric feature, (c) presenting a legal document pre-prepared for signature by the signatory, (e) re-scanning the biometric feature scanned in step (a) and (d) matching the scanned feature to one stored in step (b), validating the identifier.

In still another aspect of the invention, a method for authenticating a legal document for signing including the steps, (a) identifying by legal name all signatories of the document, (b) pre-scanning each of the signatories for a biometric feature, (c) generating digital identifiers from the scanned features for each signatory and storing those identifiers one per signatory, (d) drafting and approving the document to be signed; and (e) embedding a code identifying at least the signatories in at least one location in the document.

### BRIEF DESCRIPTION OF THE DRAWING FIGURES

FIG. 1 is an architectural view of a document processing network according to an embodiment of the present invention.

FIG. 2 is a block diagram illustrating components of a biometric security pen shown in FIG. 1.

FIG. 3 is a process flow chart illustrating steps for processing a legal document according to an embodiment of the present invention.

FIG. 4 is a perspective view of client architecture using a digital signature pad according to an embodiment of the present invention.

FIG. 5 illustrates client architecture using a biometric card reader according to an embodiment of the present invention.

FIG. 6 is a process flow chart illustrating steps for preparing a legal document for signature according to an embodiment of the present invention.

### DETAILED DESCRIPTION

The inventors provide a secure document processing network-based system that leverages biometric identification for authenticating signatories on authenticated legal documents and for online transactions. Methods and apparatus enabling the invention are described in enabling detail in the following embodiments.

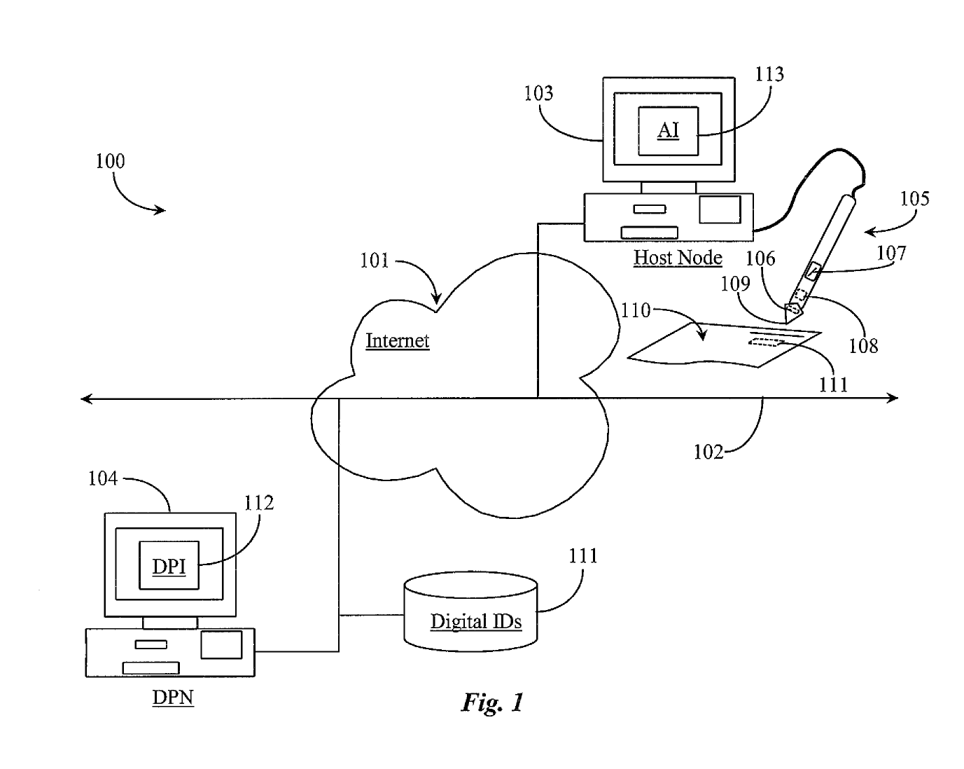

FIG. 1 is an architectural view of a document processing network 100 according to an embodiment of the present invention. Network 100 leverages a wide-area-network (WAN) 101 that is, in this example, the Internet network. The inventor chooses the Internet network as a primary carrier network because of its high public access characteristic and standard protocols. In other embodiments other networks might be leveraged such as a corporate WAN, Ethernet, Intranet, or any geographically significant publicly accessible transaction networks such as an automated transaction network (ATM).

Internet 101 is further exemplified in this embodiment by a network backbone 102. Network backbone 102 represents all of the lines, access points, and equipment that make up the Internet as a whole including connected sub-networks. Therefore, there are no geographic limitations in practice of the present invention.

Document processing network 100 includes a document preparation node (DPN) 104 connected to network backbone 102 via a network access line. Node 104 may be a desktop computer, a laptop computer, a personal digital assistant, or any other network-capable appliance also capable of preparing an electronic document. In some cases, legal documents may be prepared on a word processing computer appliance offline and then transferred to a network-connected node for service according to aspects of the present invention. In such a case, node 104 does not require the capability of editing or creating the documents.

In this example, node 104 is a desktop computer executing a browser application for network navigation. Node 104 may be connected to Internet 101 via digital subscription line (DSL), broadband, cable/modem, dialup, or any other Internet access service and equipment including wireless services.

Computer node 104 is adapted with a document preparation interface (DPI) 112 for the purpose of preparing a legal document for document authentication and legal signature. Node 104 is therefore representative of a sending party that first prepares a legal document for signing and then distributes the document to another party to the document to obtain the signatures. DPI 112 may be provided by a standalone program installed on node 104 or a server-based interface (server not illustrated). In one embodiment, DPI 112 is a browser-based plug-in that may be installed as an add-on program to any word processing program used in preparing legal documents. Microsoft Word™ and Adobe Acrobat™ are exemplary of programs that can be used to practice the invention.

Node 104 has access to a data repository or hard disc 111 that is adapted to store digital identifiers (IDs) of document signatories. Repository 111 may be internal to node 104 or it may be an external storage drive or disc. In one embodiment, repository 111 may be server-based (server not illustrated). In still another embodiment digital IDs may simply be stored in server or computer cache memory with an expiration date. In one case a digital ID is permanent and used every time a signatory has to sign a legal document.

Network 100 includes a host node 103. Like DPN node 104, host node 103 may be a desktop computer, a laptop computer, a PDA, or any other network-capable appliance capable of network access and of displaying all or a portion of a legal electronic document. Host node 103 represents a network-connected node that is adapted to receive a pre-prepared electronic document for signature and for facilitating authentication of the document and signatories and signing of the document.

Host node 103 is a desktop computer in this example, and is connected to network backbone 102 via any of the previously mentioned network service/equipment packages. Host node 103 receives an electronic document for signing from DPN node 104 over network 101. There may be more than one host node adapted for secure document signing of a document distributed by DPN 104. The inventor illustrates one sending and receiving node and deems the illustration sufficient for the purpose of explaining the present invention.

Host node 103 is termed a host node in this example because it hosts a peripheral device 105 used to provide a secure signature on a legal document. Peripheral device 105 is a computerized pen/stylus device that communicates with host node 103 through universal serial bus (USB) connection in this example. Device 105 also referred to herein as a pen or wand, may also use wireless communication such as Bluetooth™, infrared, or other wireless protocol to communicate with node 103.

Pen 105 may include one or more features depending on various embodiments for authenticating a signatory and enabling the signatory to render a verifiable signature of a document. In this example pen 105 includes an ink dispensing well and tip 109 and can be used to write on a document that has been printed out for signing such as a document 110 illustrated. Pen 105 further includes a biometric scanner 107. Biometric scanner 107 is adapted to scan in a user's thumbprint or fingerprint that can be used to validate the user as a legal signatory of a legal document.

Pen 105 also includes a motion sensor 108. Motion sensor 108 is provided for the purpose of detecting motion and orientation of the pen such as a motion sequence of a user actually signing a document such as document 110. Pen 105 communicates with a program installed on node 103 that includes an authentication interface (AI) 113 used to validate signatories to the document and, in some cases, to verify that the received document is authentic and has not been altered.

AI 113 may be a resident program installed on node 103, a browser and word processor add on or plug-in, or a server-based utility (server not illustrated). Al 113 has a feature that recognizes pen 105 when the device is plugged into a USB port or activated through a wireless interface. Pen 105 communicates directly to AI 113 when being used to verify the identity of a user and to sign a document.

Pen 105 includes an optional code scanner 106 that is capable of scanning machine code such as a printed code illustrated herein as a code 111. Code 111 may be a bar code or some other machine-legible code that can be scanned into pen 105 and ultimately read by computer node 103 running AI 113.

In practice of the present invention and according to one embodiment of the invention, an agent or agents operating node 104 may prepare a legal document for signature using DPI 112. The agent or agents may or may not by signatories on the document. If they are signatories, then document 110 may arrive at node 103 already including one or more signatures, but may require one or more additional signatures before the document is completely signed and therefore legally binding. To further exemplify, perhaps document 110 is a patent purchase agreement (PPA) requiring full and legal signatures of the buyer or buyers and of the seller or sellers in multiple places throughout the agreement, such as after each exhibit in the agreement. In such a case whichever party (buyer or seller) that prepares the agreement and gets the agreement pre-approved before signatures may be the first party to sign the document. Therefore, document 110 may be received already partially signed. In many cases of contractual transacting, the provider or seller first signs the contract followed by the buyer. The same is true with most service contracts where the service provider makes a signed offer (legal offer) and the buyer accepts the contract with a signature.

It is critical to both parties that the document is legitimate and approved by both parties and that the representatives of each party that signed the document are who they say they are. When contracts are signed without all parties present and accountable, extra security is required for assurances that everything is legal. In some cases where the parties cannot be present to witness signatures, a notary service is required to verify identity. In this example, biometric identification is used. Also in this example a thumbprint or fingerprint may serve as the biometric identification feature. However, in other embodiments other biometric features might be leveraged, such as a retina scan for example.

In general practice of the invention, one party responsible for document preparation uses node 104 and DPI 112 to prepare a finished legal document for signing. This process involves identifying all of the legal names of the required signatories to the document. Notification may be sent prior to document distribution to the signatories of a requirement for generating a digital ID for each of the parties. The signatories that will sign the document use pen 105 while it is coupled for communication to host node 103 to scan a thumb or fingerprint into the system via biometric scanner 107. The biometric ID can be used to generate a digital ID unique to each signatory. The generated IDs are sent along with the required information for each signatory (full legal name, etc.) to the document preparer operating node 104 running DPI 112.

The digital IDs for each signatory are then pre-aggregated and stored in repository 111. This may be temporary identification data or permanent identification data depending on the circumstance. For example, a user that will sign only one or a very few documents might only be required to generate a digital ID using the biometric scanning method just before each signing period. A user that spends the day signing agreements as part of a job may be required to have a permanent ID on file.

The document preparer interface (DPI) 112 is adapted to embed code into the electronic document in the form of machine readable data that can later be scanned in a printed copy of the document. Therefore, a document reference code might be generated and embedded on each page of the finished document. A rule may apply to this code embed function that prevents any page having the embedded code from being further edited. Therefore, any page printed from the document that has the code can be trusted as not having been changed since before the code was installed. The reference code might be useful for associating the particular document with all of the parties to the document including any other entities that have interest in the document.

DPI 112 may be useful for generating another machine legible code that identifies a signatory of the document at least in part using the biometric identification feature or code previously stored. This code may be presented as a bar code, for example, that could be scanned before a signatory signs the document. Both document reference code and biometric identification code could be embedded into the same machine legible code that can be placed anywhere in the document for later use.

DPI 112 may also be used to include standard information such as document title, data, time, and similar particulars into the document code. After all code has been generated and embedded into a document, it is ready for distribution to signatories. A signatory operating node 103 may receive document 110 and may elect to print the document for an ink signature using pen 105. The signatory is pre-identified by the system and can be validated as a legal signer at the time of signing.

Once a user picks up pen 105 to sign a document the user has the biometric identity feature previously submitted for generating a digital ID rescanned and stored in memory (not illustrated) of the device. The feature may be sent back over the network to the document preparation node 104, which may then validate the signatory by checking the received data against the repository 111 containing the pre-submitted digital IDs.

In one embodiment the code causes the DPI server to authenticate the document and to notify a signatory of a proper place to sign in the document. A user may first scan a barcode such as barcode 111 to verify that the signature line belongs to the user and that the document has no changes in it from the time of approval. The scanning of the code can be performed by code scanner 106 which may be a barcode reader.

In one aspect of the above-described embodiment a signatory might discover where to sign the document in multiple places by scanning code provided next to the name and signature lines. Code 111 placed immediately next to (above or below) the signature line may be scanned just before applying the signature. If the user scans the code and it does not identify that user for that line, then the particular signature line is not to be signed by that user. In one case, the user may be prevented from writing with pen 105 until just after scanner 106 detects the appropriate “signature line” code. In other words, when the scanner detects the code and verifies that the user holding the pen matches the code just scanned then the pen will be enabled to dispense ink for the time it takes to create one signature. In one embodiment, this may be performed onboard the pen for each signature required of the signatory.

In one embodiment, when a user grips pen 105 to sign a document, the biometric scanner takes another scan of the signatory's thumbprint or fingerprint and immediately uploads the biometric scan into computer node 103 via AI 110. AI 110 may then attempt to validate the signatory by generating a code that should match the signatory's digital ID stored in repository 111. In this case, node 103 aided by AI 110 contacts node 104 aided by DPI 112 and requests a match for the code just generated by an alleged signatory about to sign the document. The generated code is sent with the request. Node 104 then performs a lookup in repository 111 to determine if a match exists. If it does, node 104 confirms the identification verification and enables pen 105 to be used to sign the document.

In the latter embodiment, the document preparer is alerted by virtue of the request that a document is being signed. In the former embodiment, authentication takes place locally and can take place offline. However, motion sensor 108 may be activated during signature to record the date and time of each signature placed on the printed document. Pen 105 in that case could upload all of the information to AI 110 the next time node 103 connects to the network and an automated notification may at that time be sent to the document preparer or source notifying them that the document was successfully signed.

In one embodiment a document may have to be distributed to a first signatory, then to a second signatory, then to a third and perhaps more signatories involving multiple computer nodes connected to the network. In that case each signing event is separately recorded and separate notifications may be sent to the document preparer or source as well as copying the other signed and unsigned parties. This may be of some use in multi-party contracts where someone who has not yet signed is waiting on another party to sign as a condition of that signatory's participation.

Pen 105 may be enabled or disabled by the host system according to rules created relative to identity verification at the time of a signing event. Some electronic modification may be required if pen 105 is used as an ink pen to sign a printed document. For example, an electronically-controlled switch may be installed on device 105 for enabling or disabling ink flow from the device. Likewise, if the device is used as a stylus on a digital signing pad, for example, the pad may also be enabled or disabled.

An important purpose for device 105 is to validate that the user holding the device is an authorized signatory to a document. Actual matching of biometric data to a digital ID or other biometric data may be performed locally at host 103, at DPN node 104, or by a neutral third party system (not illustrated). In this example, peripheral device 105 is used as an ink pen on a document that has been printed. In another embodiment, device 105 may be used as a stylus as will be described further below.

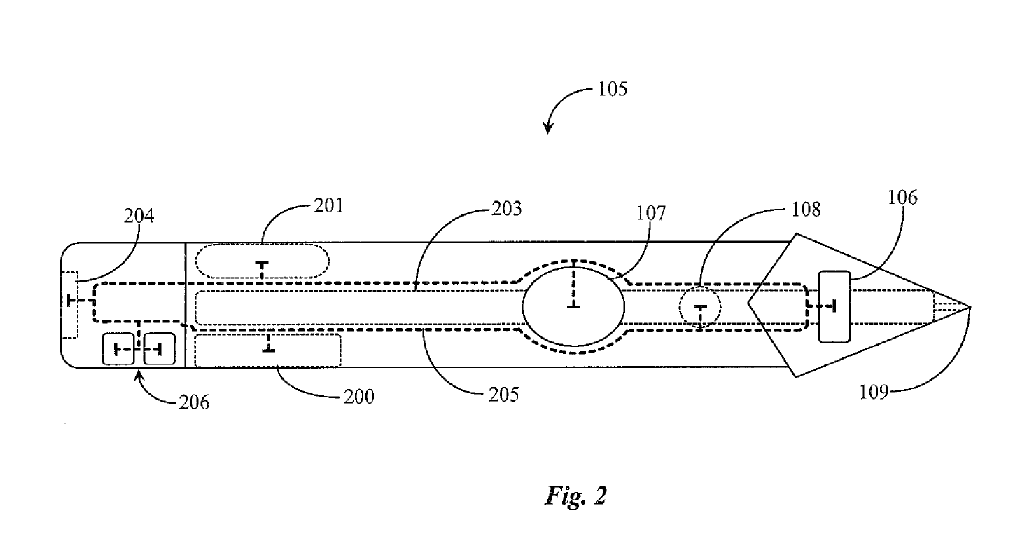

FIG. 2 is a diagram illustrating components of biometric security pen 105 of FIG. 1. Pen 105 is a computerized device that is used as a peripheral device with a computer host connected to a primary network as described further above. Pen 105 in one embodiment has a USB cable port 204 adapted to enable the device to be connected by a USB cable to a host computing device having a standard or a high speed USB port.

In this example, pen 105 has an electronic bus structure 205, illustrated logically, that serves to connect all of the required and optional components of the device for communication on the device. Device 105 includes biometric scanner 107, motion sensor 108, and code scanner 106 described further above. In this example pen 105 is used as an ink pen on printed documents. Therefore, an ink well dispensing system 203 is provided and includes a replaceable ink cartridge enabling ink to flow through tip 209.

Biometric scanner 107, motion sensor 108, and code scanner 106 are connected to electronic bus 205 and are powered through the USB interface 204 when the device is plugged into a host. In one embodiment, a pair of switch buttons 206 is provided for enabling or disabling power to the device, or for toggling between different modes of the device. In one design, pen 105 may be used as a stylus or as a ballpoint pen using a toggle switch that may be placed on the back end of the pen. Mode buttons 206 may be used to switch scanning modes from biometric scanning to bar code scanning. Set and reset functions may also be provided and enabled through buttons 206.

Biometric pen 105 has a microcontroller 201 for controlling various features and functions of the device. Microcontroller 201 is connected to bus structure 205 and may comprise software and/or firmware to enable certain base functions such as motion detection, scanning, date and time function, and so on. Pen 105 includes a memory 200 for storing scanned data before data upload into a host computer. Memory 200 may be a flash memory or some version of flash memory. In one embodiment, memory 200 may include a small portion of volatile memory for storing temporary data like digital IDs that may be downloaded to the device from the host computing appliance. In that case, actual verification of identity for a signatory may be performed locally on the device.

A small portion of code or firmware may be provided on microcontroller 201 in one embodiment for generating a digital ID on the device from fingerprint or thumbprint data retrieved by scanner 107. This may serve as a permanent digital ID for a signatory and subsequent scans may result in generation of the same ID to use for matching purposes. Part or all of such as digital ID may be rendered in the form of a code that may be scanned by scanner 106 such as a part of a bar code, for example, to verify that a particular signatory is authorized to render a signature on the document. Such a bar code may include the digital IDs of all of the signatories of a document. There are many possibilities.

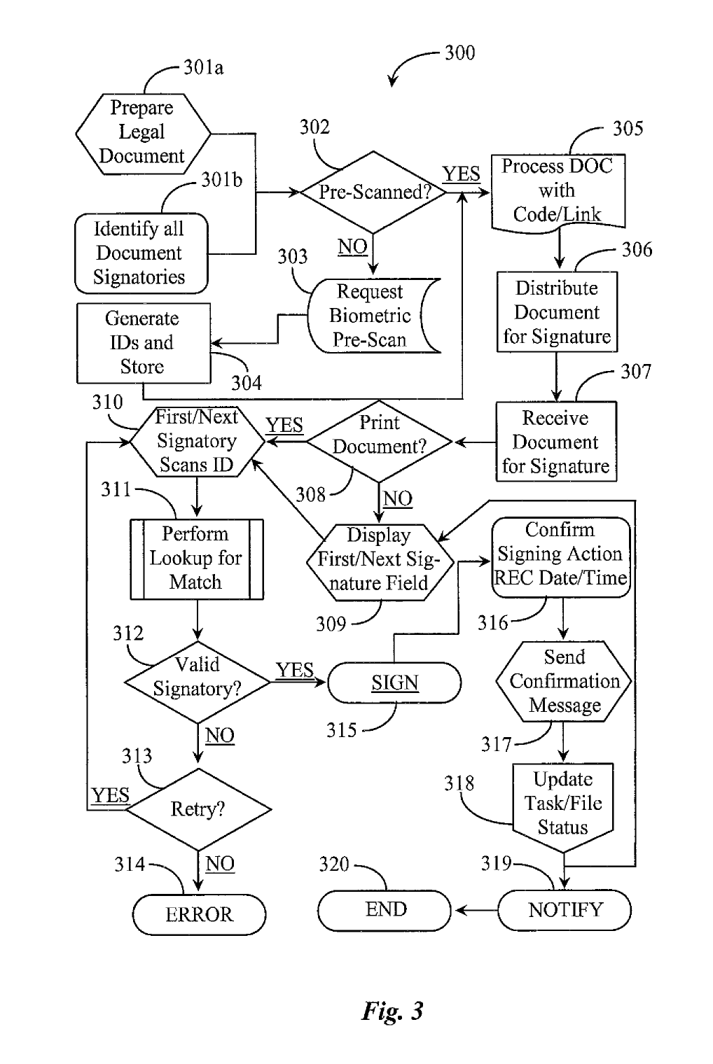

FIG. 3 is a process flow chart illustrating steps 300 for processing a legal document according to an embodiment of the present invention. At step 301a, a legal document may be prepared for preprocessing according to an embodiment of the present invention. Part of this process may include a step 301b wherein all of the intended document signatories are identified to the system. Step 301a may include preparation of the document itself including any revision and approval processes required to produce a document that is ready to be signed by all of the identified parties. Aggregation of signatory data may include the legal names, current residence addresses, contact numbers, and any other data that might be considered important to have on file for each signatory.

At step 302, the system, whether run on the document preparers system or a third party system, may make a determination if the signatories have already been pre-scanned to produce their digital IDs. If At step 302 some or all of the intended signatories do not have digital IDs on file, at step 303 a biometric pre-scan may be requested of any of the intended signatories not already in the system. Such a request may be handled in a number of ways. One way is to send an email requesting the scan with a link included that serves as an upload point on the network for the biometric data.

During a pre-scan, a user would invoke a program on a host computer such as AI 110 on host 103 and then activate biometric pen 105. When prompted, the user may grasp the pen with a thumb or finger resting on the biometric scanner. In one embodiment the scan is automatically activated when the user grasps the pen. In another embodiment, a button on the device may be depressed to activate the scan. In another embodiment, the scanner is always on and scans periodically to see who is holding the pen. For example, if an authorized signatory first holds the pen and the scan verifies the signatory to sign the document, and then hands the pen to another person not authorized to sign, the scanner on the pen may detect the transfer by scanning the next person's biometric imprint and finding that it does not match any of the approved signatories. In this case functions of the pen may be enabled or disabled accordingly.

For each signatory that submits a pre-scanned thumbprint or fingerprint to the system, the system generates a digital ID for that signatory and stores the ID. In one embodiment, imprints are stored temporarily on the pen device and then uploaded into the host computer where software on the host generated a digital ID from data received from the imprint. The ID may include numbers, characters, symbols, or the like used in specific combination to produce an ID. Enough data is retrieved and used from the scan so that the imprint itself makes the ID unique to the individual so that the next time the imprint is scanned, it can be matched to the ID without error. In one case, the imprint can be analyzed for a unique geometric signature that can be expressed in mathematic notation and used in part or as a whole to generate the signature ID for the signatory.

At step 305, the document preprocessing begins wherein information retrieved about the signatories and, in some cases digital IDs are actually embedded into the document as code that may also include a generic link to the authentication interface for retrieval of data and for verification of signatories and document authentication.

At step 302, if the signatories have been pre-scanned and have digital IDs on file, and all of the other information is at hand, then the process may jump directly to step 305. When a user displays a legal document enhanced by the present invention, the generic link embedded in the document may automatically execute invoking a separate window containing the authentication interface. Other data may be incorporated into code that may be scanned from one or more pages of the document. The document preparation interface on the document preparer side of the process enables the document to be processed by adding the embedded information such as a document reference number, a barcode that may authenticate each page of the document and may provide data about who is authorized to execute a document signature.

In one embodiment, different bar codes are applied to specific signature points in the document based on who is supposed to execute their signature at the associated signature line. In this case, a specific signature line may have a code associated with it that can be scanned in to see if it matches the signature of the person holding the pen device. This process can be performed entirely on the device itself in some embodiments. If the last biometric scan (current user holding the pen) matches the ID in the code associated to a signature line in the document then the signatory should sign there. If not then that line is reserved for the signature of another.

At step 306, a fully prepared document may be distributed for signing. There may be multiple destinations if there are multiple signatories. At step 307, a signatory or multiple signatories receives a document for signing. There are two possible options regarding signature. One is to print and sign the document using device 105 as a ball point pen. Another option is to sign the document electronically using device 105 as a stylus.

At step 307, a destination node receives the document for signature. The document may be sent as an encrypted email attachment. The document may be posted for signature whereby each destination node may download the document for signature. At step 308, the destination party makes a decision whether to print the document for signature or sign the document electronically using a digital signature pad connected to the destination node.

If at step 308, the destination party decides not to print the document, at step 309 the document displays for electronic signature. In this step, a signatory or signatories may review the document electronically before signing. Optionally, a link to sign the document may be provided in the document word processor tool bar. A signatory may click on this link to display the first signature box or line in the document window. This action may also cause the same window contents to display on a peripheral digital signature pad connected by USB or wirelessly to the destination node. In this case, the signatory will eventually sign the document digitally using the digital signature pad and device 105 as a stylus. In one embodiment, a signatory may highlight the first signature line or box using a computer mouse function such as by selecting the area including the signature field causing the contents selected to display on the screen of the digital signature pad.

At step 310, the first signatory may scan their ID into device 105 by grasping the device with the appropriate thumb or finger resting on the biometric scanner. In one embodiment, the document contains all of the signatories digital IDs embedded in code in the document. These IDs then are locally accessible to the authentication interface running alongside the document as a plug-in. The biometric scanner may scan the signatories thumb or fingerprint and a digital ID can be generated from the information on device 105 for use in validating the signatory as an authenticated signer of the document.

The biometric ID may be uploaded to the destination computer and can be used by the authentication interface to perform a lookup to match the ID to one of the digital IDs included with the document. In one embodiment, the digital IDs are not included with the code embedded into the document to be signed rather they are stored in a repository on behalf of the signatory as a permanent ID. In this case step 311 may include a network verification session between the destination computer and a verification server or the source node responsible for preparing and distributing the document.

In one embodiment, the signature box or line may include one or more codes associated with the particular signature field displayed. One of these may simply be a document reference code that associates all of the correct signatories to the same document. One of these codes may include the digital ID of the signatory whose name belongs on that particular signature line. This code may be presented as a bar code or some other code that can be scanned for a printed document or that can be read or scanned from a display. In this case, it is possible that when the signatory scans a thumbprint or finger print using device 105 as a stylus, the authentication interface will attempt to match the ID scanned to the one embedded in the code associated with that particular signature line.

If at step 308, the destination party decides to print the document or the signature page or pages of the document, then the process moves directly to step 310 after printing. In this case, no digital signature pad is required and device 105 is used as a ball point pen. In this embodiment, the signatory may scan a bar code or similar embedded code associated with the signature box or line on the printed signature page. In one case, the scan using a bar code scanner on the device lifts a particular digital ID embedded in the code. That ID may be matched with a biometric scan on the pen locally to determine if the person holding the pen is the person that should sign that particular signature line or box.

In either case of stylus and digital signature pad or printed document and pen, the actual lookup and match process to authenticate a signatory to sign the document may be performed locally on the computerized pen, on the destination computer using the authentication interface, or on a remote server representing the source document preparation node or a third party service node. The exact configuration depends on the service model being used. For example, if one or more signatories are commonly involved in rendering their signatures on legal documents as part of a job description for example, then the concept of storing permanent digital IDs for those signatories is more practical. Doctors, lawyers, mortgage brokers, chief executive officers, bank officials, and other professional in various fields often must render their signatures on a variety of legal documents on an ongoing basis. A third party service might be provided that prepares the legal documents for signing, provides the computerized pen and a digital signature pad, performs document authentication and signatory verification procedures and keeps accurate records of all of the satisfied documents for the client.

At step 312, the system determines if a particular signatory is authenticated for signing the legal document. Steps 309, 310, 311, and 312 may be repeated for each signatory at a particular destination. For example, if three signatories are present at one computer terminal where the document is displayed for signature or has been printed for signature, then the signatory verification sequence may be repeated once for each of those signatories beginning at step 310 for each signatory.

At step 312, if the system determines that a signatory is not a valid signatory that is required to sign the document, the system may make a decision whether to retry the sequence or not for the same signatory at step 313. If at step 313, the system decides to retry the sequence, the process loops back to step 310 for the same signatory. In this case, there may be a control for activating the biometric scanner to take a subsequent scan of the signatories thumb or fingerprint. In one embodiment, the biometric scanner is built to scan both a thumbprint and a fingerprint such as the thumb and index finger simultaneously. In another embodiment, the scanner is always on when connected to the host but does not register a new scan until the unit is out down and picked back up. In this embodiment, the motion sensor on the unit may initiate a new biometric scan when it senses that the unit is being picked up and held in a writing position.

If at step 313, it is determined after a failed verification attempt that no retry will be attempted, then the system may report an error at step 314. It may be that the original digital ID created for the user was faulty because of an incomplete first scan. In this case, the signatory may be given a chance to pre-register as a signatory again using a new digital ID.

If at step 312, the system validates the signatory to sign the document, then at step 315, the signatory may proceed to execute a signature at the appropriate signature area (line or box). This process may involve digitally signing the document using a digital signature pad connected to the destination node using device 105 as a stylus, or it may be where the user has printed out and signed a signature page of the document. In either case, a motion sensor on device 105 may sense the motion sequence of the signature and may confirm the signature at step 316 including recording of the date and time that the signature was actually executed. This information may be temporarily stored on the device and then uploaded into the destination computer via USB or wireless connection if the device was used as a ball point pen to physically sign a printed signature page of the document.

If a digital signature pad was used, then the date and time of the signature may be recorded by the signature pad device and uploaded into the destination node. At step 317, the destination node aided by the authentication interface may send one or more confirmation messages to the source party of the document and perhaps other interested parties that the signature event occurred. The confirmation message may include the name and digital ID of the signatory and the date and time the signature was rendered.

Digital IDs and other sensitive information about a signatory may be sent to other parties that require the information using appropriate encryption/decryption software over a secure channel for security purposes. Likewise, if signatory IDs are embedded into a document, encryption and decryption methods can be employed to secure the IDs and the document itself when being transmitted over the network.

Step 317 may be repeated as necessary for each signature, for specific ones of multiple signatures, or one confirmation message may be sent when all of the required signatures have been obtained. Any interested party may be configured to receive a confirmation message regarding the execution of one or more signatures executed in the document.

At step 318, the system may update task and file status of the document in a staging or docketing system with the latest information. For example, a user may open a task management interface or docketing system to check the status of a legal document through the signature process. The document can be tracked from the time of original distribution until the signing process has been entirely completed. For example, one check of a document status might reveal that the document has been signed by two of four signatories and the system is waiting for confirmation of the last two signatures. In this case, the document status might be labeled as “pending” until it is completely signed by all of the required signatories. In some cases, notifications may be periodically sent out to signatories in an event that they have the document for signature but for some reason have not yet signed. Knowing this information at any point in time may help to streamline the process and perhaps alert deal makers to potential problems as they might occur such as signatory that has ultimately decided to back out of a contract, for example.

At step 319, assuming that a legal document has been completely signed by all of the required signatories, the system may send notification of that status to all parties concerned. The file stored in the docketing system or task management folder may be automatically moved to a task-complete folder where administrators or workers may begin work to fulfill any goals of the signed document.

Typically, those who have printed and signed may mail their signature pages back to the source party. Those who have signed the document electronically have their signatures in the document when it is returned to the source party. The document may be reassembled with all of the appropriate signatures and can be printed out in full and stored electronically with all of the signatures in place. Final approval may be required to confirm that all of the signatures were rendered correctly according to legal name as a final step in the validating process. The process ends at step 320.

It will be apparent to one with skill in the art that there may be fewer or more steps 300 included in the process without departing from the spirit and scope of the present invention. The description and in some cases the order of steps may also be changed somewhat from the description and order illustrated herein without departing from the spirit and scope of the present invention. For example, embedded codes included in the document may be included solely for the purpose of authenticating that the document has not been changed or edited since it was originally prepared and approved for signature. An embedded code may be caused to delete or dissolve from a page that has been changed in any significant way by a user. In this case, the lack of a code on a particular page is indicative that the page was altered in some way like a change in content.

In one embodiment, such codes that can be scanned into a computerized pen device might be unique to signature areas of the document and embedded adjacent to those signature areas whereby scanning of such codes indicates which signatory is to sign at a particular signature area of the document. In still another embodiment the code embedded into a document that is retrievable by scanner might identify all of the signatories to the document but may not indicate who is to sign where in the document.

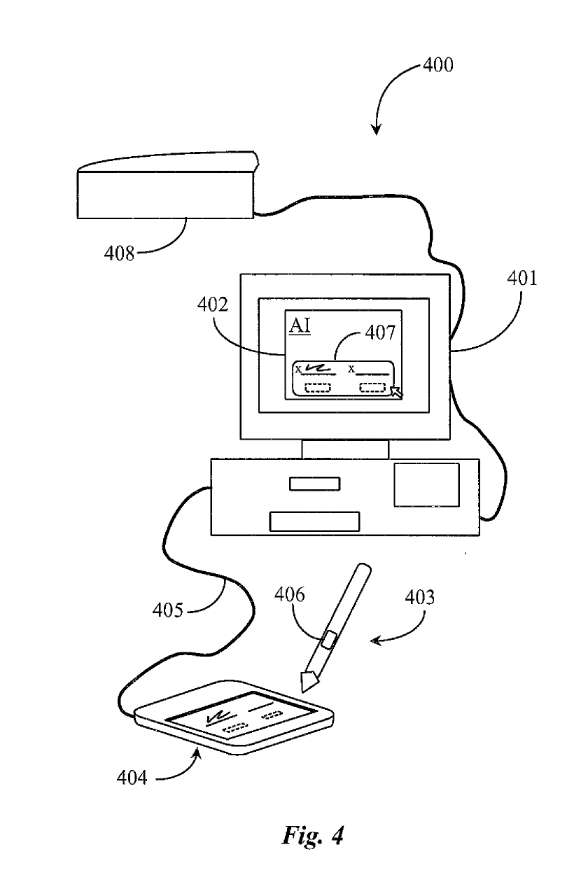

FIG. 4 is a perspective view of client architecture 400 using a digital signature pad 404 according to an alternative embodiment of the present invention. Client architecture 400 represents the destination equipment and connection that may be implemented at a location of signature of a legal document.

In this example, a destination node 401 is illustrated and is a desktop computer for discussion purposes. Computer 401 has an instance of authentication interface (AI) 402 running in the foreground. In this case, AI 402 may be automatically invoked when a user opens the pre-prepared legal document for display. The AI window may run alongside the document display window or it may be used as a container through which the document may be displayed and manipulated.

Computer 401 has a USB connection (cable 405) to digital signature pad 404 functioning as a peripheral signature interface for providing an electronic signature without printing the document. In this example, a scanner 408 is provided and is connected to computer 401. In one embodiment, scanner 408 may be considered a document acquisition source if a document to be signed is scanned into computer 401 for display instead of being electronically distributed to end node 401 via a network.

In this example, a user may highlight a document signature region of the document by using the mouse function of the computer such as by drawing a box around a signature area 407. In this case, signature area 407 includes two signature lines, one of which contains an electronic signature. Another signature line is blank and both lines are associated with codes that may be scanned into the system or can otherwise be read by the system. The code under the included signature might identify that particular signatory and may be used to validate the signatory locally for authorization to sign the document.

Digital signature pad 404 has a version of the signature area 407 or signature area 408 on screen display. As described above, this action may result by highlighting the area on the screen of computer 401. With the signature line or box displayed as signature area 408 on digital signature pad 404, the signatory may pick up stylus 403 (version of device 105) to sign the document electronically by executing the signature on device 404.

Biometric scanner 406 may scan the thumbprint or fingerprint of the signatory to validate the signatory to execute the signature. In this embodiment, stylus 403 may be linked wirelessly to digital pad 404 or to computer 401 for uploading the scan and performing the lookup to determine if the user is in fact a valid signatory. A scan may also be made of a bar code displayed just under the empty signature line on display 408 wherein the code may identify the correct signatory for that line. The biometric scan may be used to approve the signatory to sign on that line. It may be in the case of no match that a message pops up on screen informing the signatory that this is the wrong line and the correct line may then be automatically displayed for the signatory.

Using the digital signature pad, the signatories may electronically sign the document and the document may be returned to the source completely signed and legal for execution. In this case, a signature already exists in the document and the system is waiting for the signatory to sign the document.

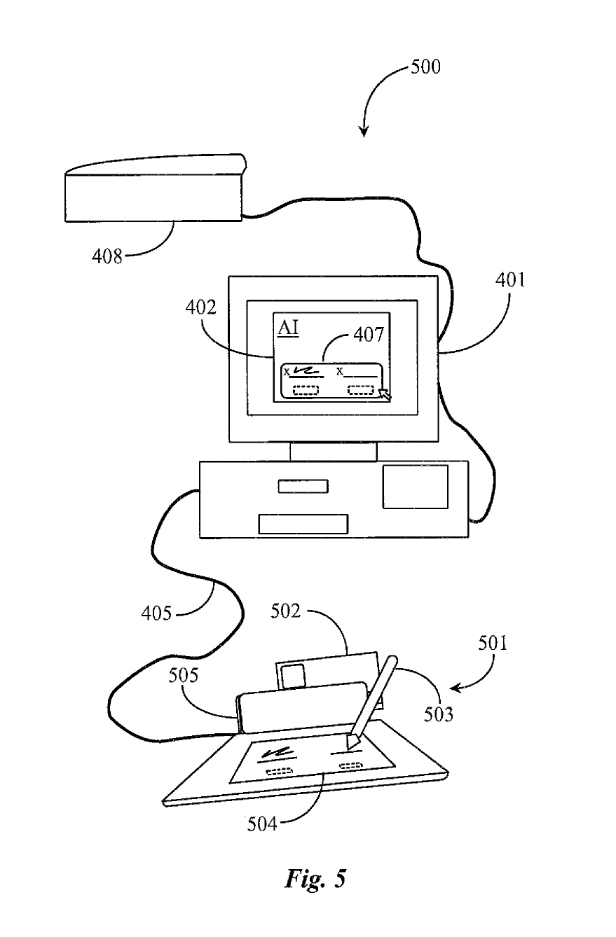

FIG. 5 is a perspective view of client architecture 500 using a biometric card reader according to an embodiment of the present invention. In one embodiment of the present invention, the system might be used to approve contracts that include transactions made with a credit card. Client architecture 500 includes computer 401, authentication interface 402, and document signature area 407 as described further above. In this case, the document might be a service contract that needs to be signed that may be linked to a payment system whereby a credit card transaction receipt may subsequently be displayed so that payment may be rendered at the time of signature of the contract. The contract might be a service agreement in one embodiment. Scanner 408 may, in one embodiment serve as a document source as previously described. For example, a contract may arrive by mail and can then be scanned into the system to complete an associated transaction and execute the contract simultaneously.

In this example, a digital card reader 501 is provided that combines functions of a digital signature pad with an ability to read a credit card 502. Card reader 501 is connected to computer host 401 by USB cable 405. A card reading station 505 is provided for the user to swipe a credit card and stylus 503 is provided for the user to sign the contract illustrated as contract signature area 504 and a subsequent credit card receipt that may be displayed after signing of the contract.

In this case, the appearance of the signature area 504 indicates that the transaction may be part of a contract that must be signed by the user before any payment is transacted. The user may have a digital ID pre-created and stored at the bank that has issued the credit card account to the user. This ID can both verify the user as the principle for signing the contract and as the owner of the account used to pay for the service specified in the contract. Therefore, there may be two signatures required, one for signing the contract and one for paying with the credit card.

In one embodiment, the inventors provide a digital mouse pad that can be used as a card reader and signature pad when not being used as a standard mouse pad. In one embodiment, reader 501 may be used simply to sign credit card transaction records online from home using device 501 and stylus 503. In one embodiment, credit card 502 contains a biometric feature of the user like a thumbprint. In this case it is not required to scan the user's thumbprint using the stylus. However, for an extra component of security to prove that the user is also the owner of the credit card used, the stylus may also be equipped with a biometric scanner and the capability of generating the digital ID from the biometric data.

If, for example, a signed roofing proposal is mailed to a person at home, the user may scan the proposal's signature page into computer 401 and AI 402. The user may select area 407 for display as area 504 on device 501. The user may then pick up stylus 501 and execute a signature using the digital signature pad portion of device 501. In one embodiment, the user's digital ID may be known to the roofing contractor or not. It may only be known to a third party service that verifies the user to the roofing contractor. The third party service may also provide the document preparation services for the contractor by identifying the legal name of the signatory and embedding the signatories ID into the contract. The third party service may also apply the digital ID to one or more accounts of the user and the bank maintaining the account or accounts may also have the digital ID on file for the user. In another embodiment, the service reserves the digital ID to validate the user's credit but not necessarily the user's signature on the contract. In still another embodiment, the user may have a digital ID for signing contracts and a digital ID for rendering payment from device 501. There are many possibilities.

Using device 501 coupled to computer 401 with AI 402 and stylus 503, a user may accept and pay for mailed proposals received as hard copies or as electronic proposals. A user's personal digital ID tied to a biometric feature of the user may be stored for match to verify that the user is the principle that should sign a contract and that the user is the authorized owner or co-owner of the account used to pay for the services specified in the contract. Simple online purchases may also be completed from home using the consumer version of the present invention as illustrated herein. Instead of entering credit card information online in a form, the user may swipe the card at the local reader and may be validated by the credit card company that issued the card using the digital ID of the user. This ID may be required at the time of signature of the credit card transaction and may be provided through the biometric scanner on the stylus and then it can be matched with the digital ID on file with the credit card issuer or bank responsible for paying on the account. There are many possibilities.

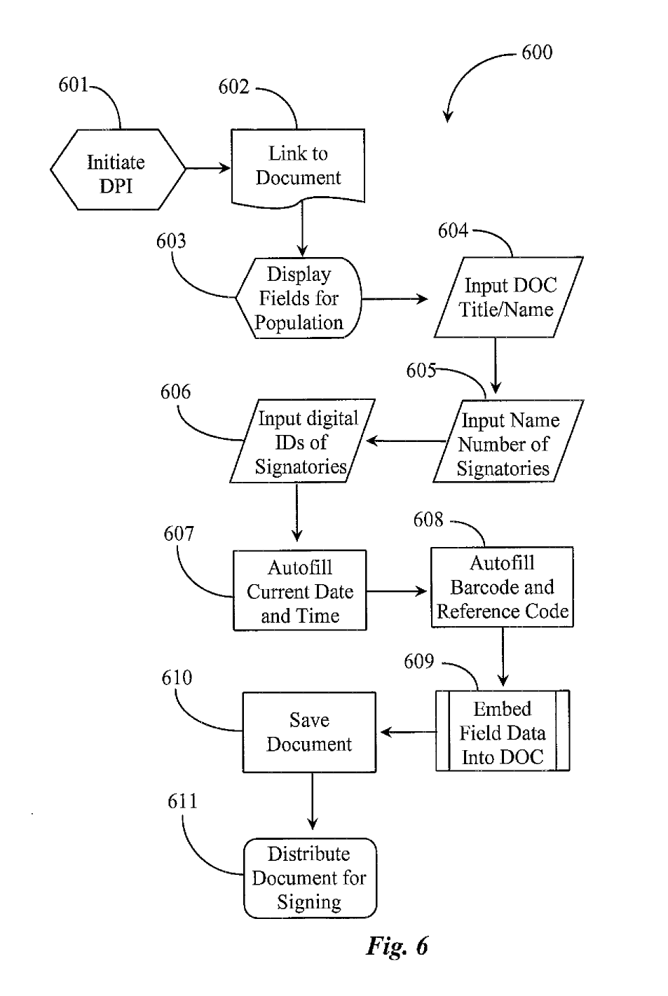

FIG. 6 is a process flow chart illustrating steps 600 for preparing a legal document for signature according to an embodiment of the present invention. A step 601, a user operating a word processing computer node invokes a document preparation or processing interface (DPI). In this step, the drafter of the document may also be the pre-processor of the document for signature acquisition. At step 602, the interface creates a link in the document that opens an authentication interface at the destination device. The authentication interface may be a universal resource served by a network-based server the interface having a universal resource locator (URL) that comprises the link. In another embodiment, the interface may be a locally resident interface that is invoked when the user opens the prepared legal document after receipt thereof electronically.

At step 603, a window appears in the DPI interface that contains several links for population with data. At step 604, the document preparer may input a document tile or name for the legal document. At step 605, the preparer may input the names of and the total number of intended signatories. The names input are the full legal signing names of each signatory to the document. The total number of signatories is just an arbitrary entry and can be optional.

At step 606, the preparer may input the digital IDs of all of the signatories. These tuples may be associated with the correct names all in separate blocks such as signatory 1_name_digital ID_signatory 2_name_digital ID_and so on. The names and digital IDs provide authenticating information relative to who may and who must sign the document before it can be executed as a legal document.

At step 607, the current date and time of the document preparation procedure may be entered by default automatically in the appropriate fields. At step 608, a function may be initiated for generating a bar code and a document reference code. A document reference code can be used to associate loose signature pages back to the same document. A barcode may contain the information identifying signatories including their digital IDs. The presence of the embedded codes may be required on each of the document pages to authenticate that the document is in its original state and has not been edited by any additional party including any of the signatories. For example, an edit made to a page may result in loss of embedded code for that page serving as an indication that the page has been altered somehow.

In one embodiment, a barcode includes content information such as the number of words of each paragraph on a page, the total number of words or characters on the page and perhaps even identification and location placement of random words throughout the page. In this case, a different barcode may be provided for each document page. The barcodes for signature pages may include the ID(s) of the correct signatory or signatories for that page as well as the page integrity information. In this case scanning the barcode can verify the correct signatories or signatory for that page and can authenticate that the page has not been changed since preparation and approval for signature.

At step 608 then the document processing interface auto fills the bar code and document reference data for use in document printing and verification of signatories. At step 609 the interface embeds the appropriate field data collected into the document according to enterprise rules. In one embodiment, the personal IDs of each signatory are embedded into and therefore are retrievable from the document itself making validation possible locally at the signing destination.

At step 610 the user may save the document as ready for distribution for signature. At step 611, the document may be distributed for signing. A distributed document may be signed by multiple parties at multiple destinations with each parties' signed signature page sent back to the source for electronic merge to reproduce the original document as a completely signed and legally executable document that may be kept on file and printed for hard copies. User's who print signature pages out for ink signature can scan those into their computer interfaces where those pages may be electronically sent back to the source for merge. The process of mailing signed documents requiring notary services is not necessary as long as adequate verification of the electronic or hardcopy signature can be made by personal ID matching of each signatory at the time of signature execution.

It will be apparent to one with skill in the art that the secure signature and verification system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A system for rendering a secure digital signature comprising:
a computerized signature tool for rendering a signature;
an identity verification program accessible to the computerized signature tool; and
a biometric scanner coupled to or integrated with the computerized signature tool;
characterized in that a signatory uses the computerized signature tool to render a signature, the user is authenticated as a signatory by retrieving a biometric identifier from the user via the biometric scanner and matching the retrieved biometric identifier to a pre-stored biometric identifier via the identity verification program.

2. A computerized signature tool for signing a printed document comprising:
an ink dispensing well and tip for controlling ink flow;
a biometric scanner for scanning a biometric identifier;
a motion sensor for sensing motion of the dispensing tip;
an onboard memory for storing biometric data and motion data; and
a digital communication link to a host computing device.

3. A secure document processing and signature authentication network comprising:
a first computer node for preparing a document for signature by pre-identifying all of the signatories to that document;
a data storage system accessible to the first computer node for storing biometric identifiers of the pre-identified signatories;
a second computer node in communication with the first computer node, the second computer node for receiving the prepared document from the first computer node and for presenting the document for signature;
characterized in that the presented document identifies the required signatories and wherein the second computer node cooperates with the first computer node to authenticate each signatory upon signing, the second computer node recording the signature process and providing date and time sensitive notification of successful completion of each signature.

4. Using a computerized signature tool, the tool coupled to or integrated with a biometric scanner, a method for authenticating a signatory of a legal document comprising the steps:
(a) pre-scanning a biometric feature of the signatory;
(b) generating biometric identifier of the signatory from the pre-scanned biometric feature;
(c) presenting a legal document pre-prepared for signature by the signatory;
(e) re-scanning the biometric feature scanned in step (a); and
(d) matching the scanned feature to one stored in step (b), validating the identifier.

5. A method for authenticating a legal document for signing comprising the steps:
(a) identifying by legal name all signatories of the document;
(b) pre-scanning each of the signatories for a biometric feature;
(c) generating digital identifiers from the scanned features for each signatory and storing those identifiers one per signatory;
(d) drafting and approving the document to be signed; and
(e) embedding a code identifying at least the signatories in at least one location in the document.
